(19) United States
(12) Patent Application Publication
(10) Pub. No.: US 2014/0246615 A1
(43) Pub. Date: Sep. 4, 2014

(54) Systems and Apparatuses for a Simplified Solenoid Valve Assembly

(71) Applicant: EMERSON ELECTRIC CO., St. Louis, MO (US)

(72) Inventors: Gregory Volz, Pequannock, NJ (US); Roy B. Bogert, Lincoln Park, NJ (US)

(73) Assignee: EMERSON ELECTRIC CO., St. Louis, MO (US)

(21) Appl. No.: 13/783,652

(22) Filed: Mar. 4, 2013

(51) Int. Cl. F16K 31/06

(52) U.S. Cl. CPC F16K 31/061
USPC 251/129.15

(57) ABSTRACT

Applicants have created systems and apparatuses for a simplified solenoid valve assembly adapted to control the flow of a fluid. The apparatus can include an upper component formed as a single manufactured component comprising a body and a core tube and a lower component formed as a single manufactured component comprising a seat insert and a core. The apparatus can further include a coil adapted to regulate an amount of fluid flowing through the apparatus and the upper and lower components can be formed as separate units coupled to one another with a coupler. The system can include the apparatus and a manifold that is adapted to be coupled to the upper component. By forming the upper and lower components as single manufactured components, the resulting simplified solenoid valve assembly can be manufactured with fewer components, with a reduced manufacturing cost and decreased complexity, as compared to traditional valve assemblies.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

1. Field of the Invention

The inventions disclosed and taught herein relate generally to valve assemblies, and more specifically relate to improved solenoid valve assemblies of the type having a small number of molded plastic body elements that can be manufactured with fewer components than traditional valve assemblies.

2. Description of the Related Art

The inventions disclosed and taught herein are directed to improved systems and apparatuses for controlling the flow of a fluid. Although these inventions can be used in numerous applications, the inventions will be disclosed in only a few of many applications for illustrative purposes.

Solenoid valve assemblies conventionally comprise a valve body having a fluid valve therein and an electromagnetic device for actuating the valve in response to an electric current. The electromagnetic device typically comprises a core tube assembly, including a fixed pole piece and a slidable plunger retained in a core tube, and an electromagnetic coil assembly surrounding the core tube to create magnetic flux and movement of the plunger.

It is desirable to be able to mount different coil assemblies on the core tube both for replacement purposes and for selection purposes due to different power requirements for certain valves and applications and because of the different power sources in existence. It is also desirable, on a production line basis, to be able to rapidly and accurately assemble or interchange coil assemblies on various valve structures, both of which may be slightly different in size due to manufacturing tolerances and the like. Traditional solenoid valves often comprise a multitude of interworking parts that complicate the manufacturing process, increase production costs, and adversely affect an operator's ability to quickly and easily interchange these parts as needed.

What is required, therefore, is a simplified solenoid valve that reduces the overall complexity of the valve by incorporating multiple components into one or more single manufactured components. As a result, the simplified solenoid valve assembly can be manufactured with fewer components, with a reduced manufacturing cost and decreased complexity, as compared to traditional valve assemblies.

Accordingly, the inventions disclosed and taught herein are directed to solenoid-type valves having a simplified construction that overcome the problems as set forth above.

### BRIEF SUMMARY OF THE INVENTION

Applicants have created systems and apparatuses for a simplified solenoid valve assembly adapted to control the flow of a fluid. The apparatus can include an upper component formed as a single manufactured component comprising a body and a core tube and a lower component formed as a single manufactured component comprising a seat insert and a core. The apparatus can further include a coil adapted to regulate an amount of fluid flowing through the apparatus and the upper and lower components can be formed as separate units coupled to one another with a coupler. The system can include the apparatus and a manifold that is adapted to be coupled to the upper component. By forming the upper and lower components as single manufactured components, the resulting simplified solenoid valve assembly can be manufactured with fewer components, with a reduced manufacturing cost and decreased complexity, as compared to traditional valve assemblies.

The apparatus for controlling the flow of a fluid can include an upper component comprising a body and a core tube, wherein the upper component is formed as a single manufactured component and a lower component, comprising a seat insert and a core, wherein the lower component is formed as a single manufactured component. The apparatus can further include a coil adapted to regulate an amount of fluid flowing through the apparatus and the upper component and the lower component can be formed as separate units and adapted to be coupled to one another with a coupler, such as a weld joint.

Further, the apparatus can include a fastener that is adapted to couple the coil to the upper component, a disc that can be adapted to couple to the core, and a diaphragm. The diaphragm can be adapted to isolate the seat insert from the disc, or the diaphragm can include a piloted diaphragm adapted to be disposed between the seat insert and the disc. The apparatus can further include a seal that is adapted to be disposed between the upper and lower components.

Still further, the apparatus can include first and second ports—arranged as inlet ports and outlet ports, respectively—disposed at a first angle with respect to the apparatus. The first angle can include, for example, a one-hundred and eighty-degree angle or a ninety-degree angle and the first and second ports can further comprise a flange.

The system for controlling the flow of a fluid can include an apparatus that can include an upper component comprising a body and a core tube, wherein the upper component is formed as a single manufactured component—such as with molded plastic, or other molded or single-formed materials—and a lower component, comprising a seat insert and a core, wherein the lower component is formed as a single manufactured component. The system can further include a manifold, wherein the upper component is adapted to be coupled to the manifold.

Further, the system's apparatus can include a coil adapted to regulate an amount of fluid flowing through the apparatus and the upper component and the lower component can be formed as separate units and adapted to be coupled to one another with a coupler, such as a snap-fit device. The upper component can further include a boss adapted to receive a connector, such as a screw. The core can include a float-style core and the coil can include a solenoid, where the flow of the fluid is regulated by the amount of current flowing through the solenoid. The system can further include first and second ports—adapted to be coupled to a conduit—wherein at least one of the first and second ports comprise a flange.

### BRIEF DESCRIPTION OF THE SEVERAL VIEWS OF THE DRAWINGS

The following figures form part of the present specification and are included to further demonstrate certain aspects of the present invention. The invention may be better understood by reference to one or more of these figures in combination with the detailed description of specific embodiments presented herein.

FIG. 1A illustrates a front cross-sectional view of a first embodiment of an apparatus for controlling the flow of a fluid.

FIG. 1B illustrates a front cross-sectional view of a second embodiment of the apparatus for controlling the flow of a fluid.

FIG. 2 illustrates a front view of an embodiment of the apparatus for controlling the flow of a fluid including an isolation diaphragm.

FIG. 3 illustrates a front view of an embodiment of the apparatus for controlling the flow of a fluid including a piloted diaphragm.

FIG. 4 illustrates a front view of a first embodiment of a system for controlling the flow of a fluid.

While the inventions disclosed herein are susceptible to various modifications and alternative forms, only a few specific embodiments have been shown by way of example in the drawings and are described in detail below. The Figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art and to enable such person to make and use the inventive concepts.

### DETAILED DESCRIPTION OF THE INVENTION

The Figures described above and the written description of specific structures and functions below are not presented to limit the scope of what Applicant has invented or the scope of the appended claims. Rather, the Figures and written description are provided to teach any person skilled in the art to make and use the invention for which patent protection is sought.

Those skilled in the art will appreciate that not all features of a commercial embodiment of the invention are described or shown for the sake of clarity and understanding. Persons of skill in this art will also appreciate that the development of an actual commercial embodiment incorporating aspects of the present invention will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation, location and from time to time. While a developer's efforts might be complex and time-consuming in an absolute sense, such efforts would be, nevertheless, a routine undertaking for those of skill in this art having benefit of this disclosure.

It must be understood that the inventions disclosed and taught herein are susceptible to numerous and various modifications and alternative forms. Lastly, the use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the Figures and are not intended to limit the scope of the invention or the appended claims.

The terms “couple,” “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and can further include without limitation integrally forming one functional member with another in a unity fashion. The coupling can occur in any direction, including rotationally.

Overview

The inventions described herein related to valves, and more specifically solenoid valves, that incorporate the core tube and body into one, single manufactured component and the seat insert and core into a second, single manufactured component, thus reducing the overall manufacturing cost and complexity of the valve. This is possible through the use of plastic injection molding that allows these separate components to be combined into one single manufactured component which, in turn, also allows for an improved component complexity and geometry that are otherwise impractical in machined and stamped parts. Further, the molded body can permit the incorporation of features to retain the coil and magnetic yoke of the solenoid valve, thus eliminating fasteners and labor required by traditional style valve designs.

In this unique construction, the elastomeric components, along with the seat insert, etc., can be easily replaced without removing the valve body from the system in which it has been installed. To further reduce manufacturing costs, the seat insert is easier to inspect and repair as compared to traditional valves where the valve seat is recessed in the valve body. The increased complexity of traditional style valves makes inspection difficult and in some cases requires one to destroy the inspected parts through sectioning to obtain accurate measurements.

In contrast, this invention, through its unique design and configuration, improves this inspection process without requiring the sacrifice of those components through sectioning for measurement. Finally, this invention and its unique configuration is versatile in that it is adaptable to several different valve connections and internal operation options as described in greater detail below.

Applicants have created systems and apparatuses for a simplified solenoid valve assembly adapted to control the flow of a fluid. As used herein, the term “fluid” refers to a liquid as well as a gas, wherein both the liquid and the gas may further comprise a solid phase. The apparatus can include an upper component formed as a single manufactured component comprising a body and a core tube and a lower component formed as a single manufactured component comprising a seat insert and a core. The apparatus can further include a coil adapted to regulate an amount of fluid flowing through the apparatus and the upper and lower components can be formed as separate units coupled to one another with a coupler. The system can include the apparatus and a manifold that is adapted to be coupled to the upper component. By forming the upper and lower components as single manufactured components, the resulting simplified solenoid valve assembly can be manufactured with fewer components, with a reduced manufacturing cost and decreased complexity, as compared to traditional valve assemblies.

As referenced above, the fluid described throughout this disclosure can include, but is not necessarily limited to, any liquid, gas, gaseous-like substances, or other media that is adapted to flow from a first location to a second location. For example, the fluid can include water or other aqueous-based solution. Moreover, fluid can include a gas-type (e.g., oxygen gas), or any other media subject to movement and/or adapted to flow with respect to the apparatuses and systems described throughout this disclosure.

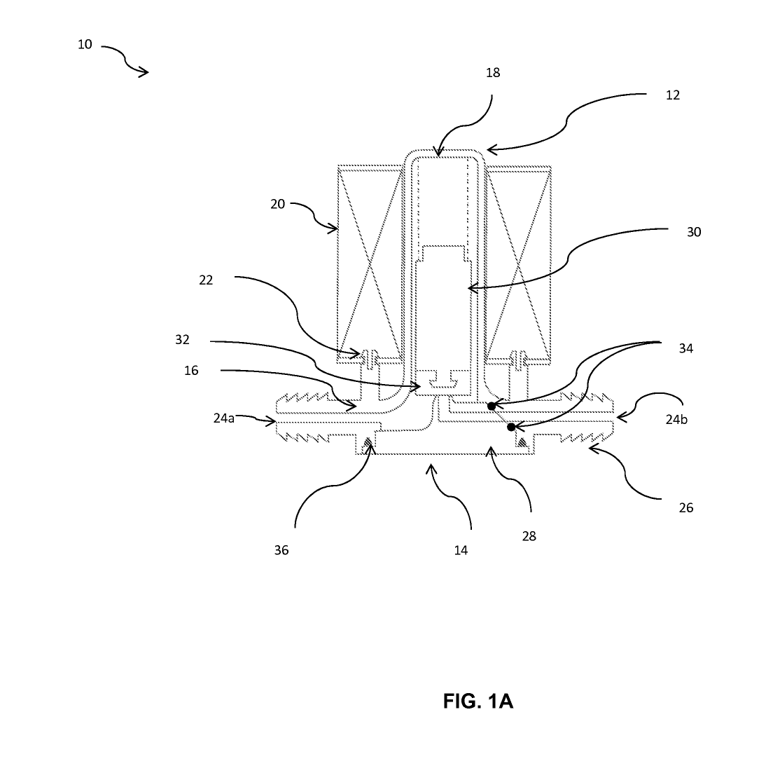

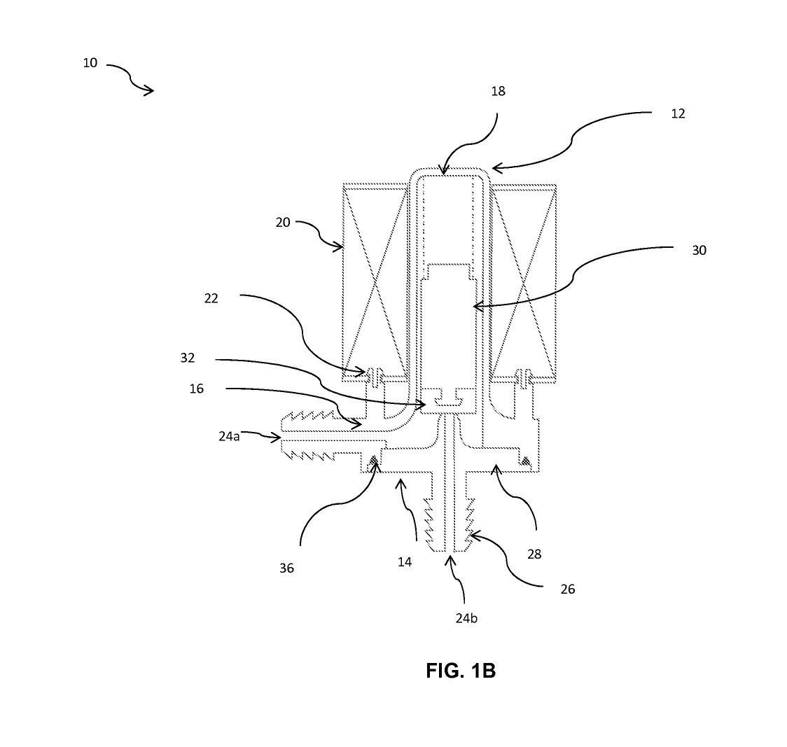

Referring specifically to the figures, FIG. 1A illustrates a front cross-sectional view of a first embodiment of an apparatus for controlling the flow of a fluid. FIG. 1B illustrates a front cross-sectional view of a second embodiment of the apparatus for controlling the flow of a fluid. These figures will be described in conjunction with one another.

The apparatus 10 for controlling the flow of a fluid can include an upper component 12 and a lower component 14. The lower component 14 can include a seat insert 28 and a core 30, formed as a single manufactured component, as described in greater detail below. The upper component 12 can include a body 16 and a core tube 18, formed as a single manufactured component.

The upper component 12 can be formed as a single unit including the body 16 and core tube 18 formed out of molded plastics, polymers, or other synthetic or semi-synthetic organic solids that are malleable and/or adapted to be formed by a mold. For example, upper component 12 can be formed through a molding process, such as injection molding, using one or more metals, elastomers, thermoplastics, or thermosetting polymers for forming core tube 18 and body 16 (and other components as well, such as, for example, a bonnet (not shown)), into a single component.

Body 16 can include a structure for supporting one or more components of apparatus 10. For example, body 16 can support coil 20, and other components (e.g., a bonnet (not shown) and/or components typically found as part of a solenoid valve (e.g., constituent components of a globe-type solenoid valve), such as a yolk (not shown), yolk assembly (not shown), and the like. Coil 20 can include a solenoid coil, or device with one or more loops of wire or other conductive conduit that can convert electric-magnetic forces into a mechanical and/or linear forces (e.g., to act as a transducer). For example, as current passes through coil 20, a magnetic field can be created thus causing a valve, actuator, or pneumatic (not shown) to activate a switch (not shown) to open and/or close core 30 which, for example, can act as valve (such as a direct acting valve, a piloted valve, etc.) as core 30 moves through core tube 18.

Core tube 18 can be adapted to be formed to house the core 30 (as described in greater detail below). For example, core tube 18 can be formed as a cylindrically-shaped hollowed out cavity, although other shapes are contemplated as well. For example, without limitation, spherical, cubic, or any other geometric shape suitable for receiving the core 30 and adapted to a provide a sufficient area for permitting the core 30 to move within core tube 18 to adjust the amount of fluid flowing from ports 24a, 24b (as described in greater detail below) driven, in part, by the forces created by coil 20.

Coil 20 can be coupled to one more elements of apparatus 10, for example, body 16. In one example, coil 20 can be coupled to body 16 through the aid of one or more fastener 28. Fastener 28 can include any bracket, support, mount, coupler, fastener, screw, bolt, clip, adhesive, or the like for coupling coil 20, yolk assembly (not shown), etc., to one or more elements of apparatus 10, such as body 16. In an exemplary and non-limiting illustrative embodiment, fastener 28 can include a snap-on and/or snap-fit device, such as a clip to couple the body 16 to the coil 20. With this snap-on type configuration, components (such as coil 20) can be quickly and easily coupled to, and decoupled from, other portions of the apparatus without the additional need of hardware and/or other tools.

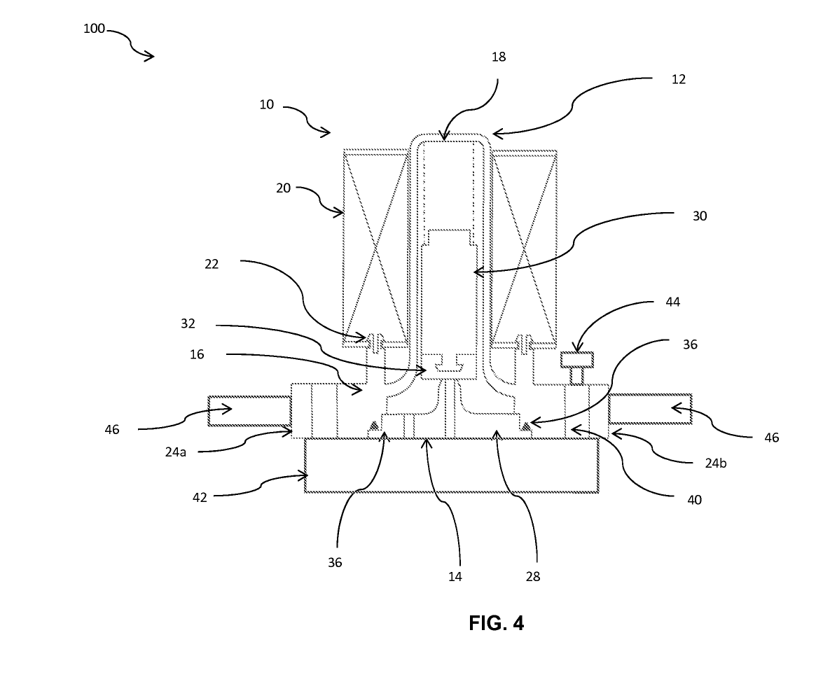

Apparatus 10 can further include one or more ports, 24a, 24b, that can, in one particular example, be formed as part of body 16. Ports 24a, 24b can include an opening, orifice, aperture, conduit, or any other channel or tube-like structure for permitting the flow of a fluid from one location of apparatus 10 to another. For example, port 24a can include an inlet port and port 24b can include an outlet port. In other examples, the flow of the fluid can be reversed, or port 24a and 24b can both act as inlet and outlet ports depending on the mode of operation of the apparatus 10. Ports 24a and 24b can include one or more flange 26, as described in greater detail below in conjunction with FIG. 4.

With specific reference to FIG. 1A, ports 24a and 24b can be disposed at an angle of one-hundred and eighty degrees with respect to the apparatus such that fluid can flow from one side of apparatus 10 to another when core 30 is slidably adjusted to a position within core tube 18. In FIG. 1B, another embodiment is illustrated where ports 24a and 24b can be disposed at a ninety-degree angles from one another with respect to apparatus 10 such that the fluid can flow from one side of apparatus 10 to a bottom portion of lower component 14, such as seat insert 28. Although not specifically shown, additional ports 24 can be added and disposed at various angles. For example, ports 24 can be added so that apparatus 10 can act as a two-way, three-way, or four-way valve. Additionally ports in various configurations are contemplated as well.

Lower component 14 can be formed as a single unit including one or more of the seat insert 28, core 30, and disc 32 (and other components as well, such as, for example, a core spring (not shown)). As described above with reference to upper component 12, lower component 14 can be formed out of molded plastics, polymers, or other synthetic or semi-synthetic organic solids that are malleable and/or adapted to be formed by a mold. For example, upper component 14 can be formed through an injection molding for molding and/or forming one or more of the seat insert 28, core 30, disc 32, and core spring (not shown) which, for example, can include any biasing device capable of storing and releasing potential energy through a flexing and/or contracting-type motion.

The seat insert 28 can include the bottom portion of the apparatus 10 such that when it is coupled to one or more portions of upper component 12, it forms the apparatus 10 (for example, a valve). In one example, seat insert 28 can be coupled to a manifold 42 (as shown in FIG. 4), or any other component one wishes to couple to apparatus 10 (as described in greater detail below with reference to specific applications of apparatus 10).

In addition to the seat insert 28, lower component 14 can include core 30. Core 30 can include a shaft or other elongated member that is adapted to adjust its position within at least a portion of core tube 18. Core 30 can include other components not shown as well such as a core spring, a fixed member, and/or a slidable plunger. As core 30 adjusts its position within core tube 18, core 30 either permits or restricts the flow of a fluid between or among ports 24. For example, core 30 in the position shown in FIGS. 1A and 1B can impede the flow between ports 24a and 24b. In one example, core 30 can be configured such that apparatus 10 is in a “normally open” configuration. In other examples, core 30 can be configured such that apparatus 10 is in a “normally closed” configuration.

As core 30 adjusts its position (for example, moving in an upward direction as illustrated in FIG. 1A with the dashed lines drawn within core tube 18), core 30 (and by extension disc 32 to which it can be coupled) can be positioned such as to permit the fluid to flow between ports 24a and 24b. Core 30 can include a float-style core. In this example, core 30 can be implemented without the need of a valve “click” and/or plugnut as required in traditional valve assemblies.

Disc 32 can include a core disc, for example, to improve the ease and convenience of making and/or inspecting boring operations of the core 30. Disc 32 can be coupled to core 30 through a snap-on or snap-fit device, such as clips, clasps, or the like. To complete the formation of apparatus 10, upper component 12 and lower housing 14 can be coupled to one another through one or more couplers 36. Couplers 36 can include one or weld joints, snap-fit devices (such as brackets, clips, clasps, or the like), etc. for either temporarily or permanently coupling the upper component 12 and lower housing 14 to one another. Alternatively, coupler 36 can include one or more brackets, supports, mounts, fasteners, screws, bolts, clips, adhesives, or the like for coupling the upper component 12 and lower component 14 to one another.

In addition to coupler 36, seal 34 can be disposed between upper component 12 and lower component 14 to create a seal (such as, for example, an air-tight, water-tight or other liquid-tight or fluid-tight seal) between these two components. Seal 34 can include one or more gaskets, 0-rings, sealants, adhesives, or other seals, or the like that are adapted to seal the upper component 12 and lower component 14. The apparatus 10 can further include a coil 20 and a fastener 22 such that the coil 20 is adapted to be removably coupled to the fastener 22.

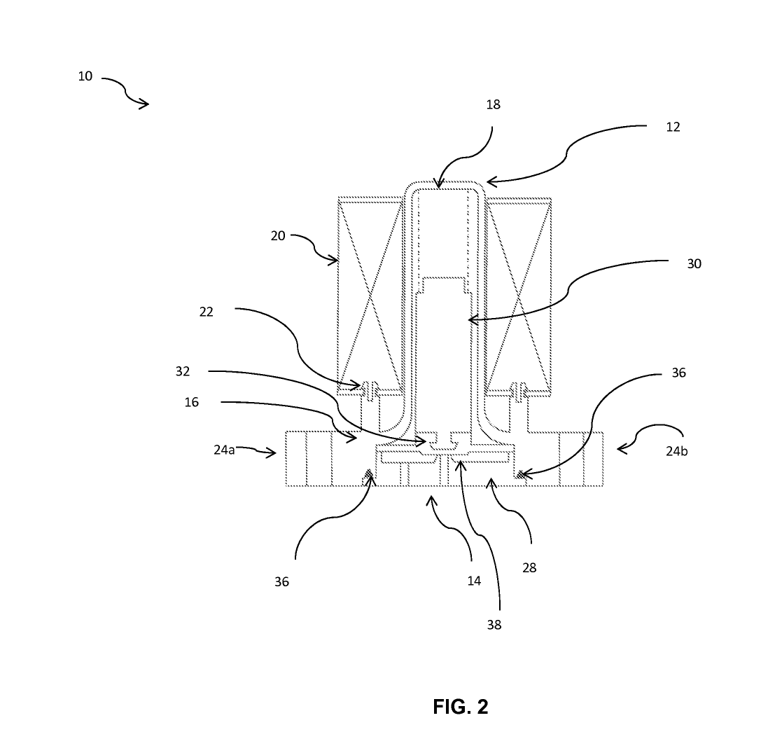

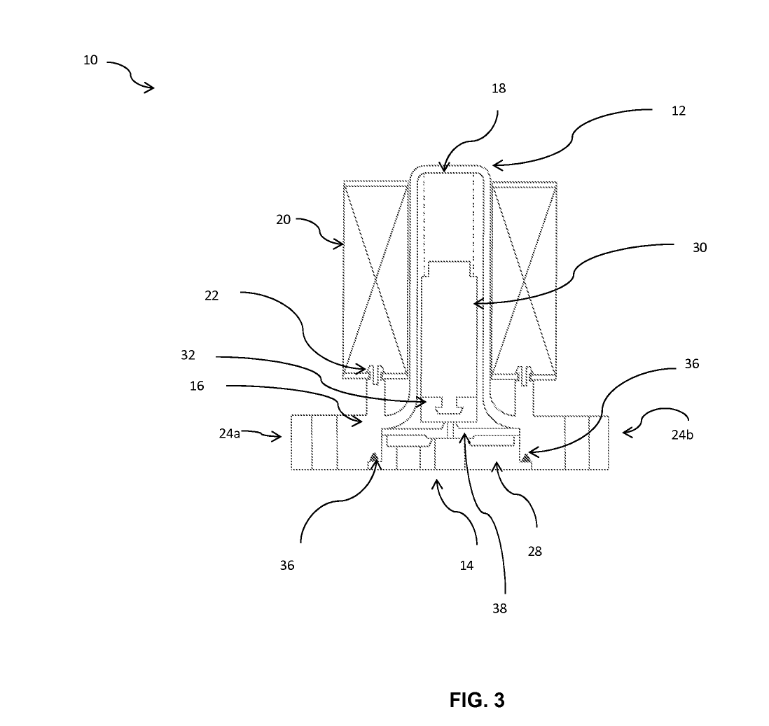

FIG. 2 illustrates a front view of an embodiment of the apparatus for controlling the flow of a fluid including an isolation diaphragm. FIG. 3 illustrates a front view of an embodiment of the apparatus for controlling the flow of a fluid including a piloted diaphragm. These figures will be described in conjunction with one another.

FIGS. 2 and 3 share many of the illustrated features of the described inventions illustrated in FIGS. 1A-1B, above. For example, referring specifically to FIG. 2, the exemplary apparatus 10 illustrated in this Figure shares many common elements with the exemplary apparatuses 10 in FIGS. 1A and 1B (e.g., upper component 12, lower component 14, body 16, etc.). All of these features are described in detail with reference to FIGS. 1A-1B and, thus, in the interest of clarity and brevity, will not be repeated for the description for FIGS. 2 and 3 below.

In addition to the elements described in conjunction with FIGS. 1A and 1B, above, apparatus 10 of FIGS. 2 and 3 can include diaphragm 38. The diaphragm 38 can be adapted to isolate the seat insert 28 from the disc 32 and/or core 30. In this embodiment (as shown, for example, in FIG. 2), diaphragm 38 can serve as an isolation diaphragm for isolating these elements. More particularly, when diaphragm 38 is employed as an isolation diaphragm, the apparatus 10 can act as an isolation valve to completely or partially obstruct the flow of a fluid through apparatus 10. For example, the flow can be partially or completely obstructed depending on the substance flowing through apparatus 10 and/or the flow can be regulated or controlled by limiting its flow to only one or a few particular elements of apparatus 10.

Alternatively, diaphragm 38 can be embodied as a piloted diaphragm (as shown, for example, in FIG. 3). In this embodiment, apparatus 10 can be employed to regulate and/or control only a small flow volume (i.e., pilot flow) through apparatus 10.

This apparatus 10 can multiple this pilot flow to control and/or regulate the flow of a greater volume through apparatus 10 (i.e., to control the flow through a larger area). In this configuration, line pressure can be used to assist the operation of apparatus 10 when acting as a valve.

Diaphragm 38 can include any membrane, flexible diaphragm, dividing membrane, or any other sheet, disk, or the like adapted to adjust its position (i.e., flex) when acted upon by a force—e.g., diaphragm 38 can flex when acted upon by core 30. In one example, core 30 can include a spring (not shown) or other biasing device for biasing the position of core 30 with core tube 18 in an “open” or “closed” position depending on the application of apparatus 10. Diaphragm 38 can be coupled to the seat insert 28, disc 32, or other portion of upper component 12 and/or lower component 14.

FIG. 4 illustrates a front view of a first embodiment of a system for controlling the flow of a fluid. FIG. 4 shares many of the illustrated features of the described inventions illustrated in FIGS. 1A-1B, above. For example, the exemplary apparatus 10 illustrated in this Figure shares many common elements with the exemplary apparatus 10 in FIGS. 1A and 1B (e.g., upper component 12, lower component 14, body 16, etc.). All of these features are described in detail with reference to FIGS. 1A-1B and, thus, in the interest of clarity and brevity, will not be repeated for the description for FIG. 4 below.

The system 100 for controlling the flow of a fluid can include upper and lower components 12 and 14, respectively (as described above, for example, with reference to FIGS. 1A-3), and a manifold 42. Although not shown in the Figure, the system can include other elements as well that replace and/or supplement the manifold 42. For example, the system 100 can include one or more pipes or other tubes or channels (not shown), switches (not shown), or other elements typically coupled to a valve used in one or more various applications, including, but not limited to, Hot Water/Steam, Potable Water and Food Service, Vacuum, Cryogenic and Liquid CO₂, Air Operated, Proportional, Intrinsically Safe, Low Power, Isolation/Shielded Core, Long Life/Quiet, Ammonia, Dry Air, Magnetic Latching and Medical/Analytical, and/or General Service applications.

Apparatus 10 of system 100 can be coupled to manifold 42, manifold mount (not shown), or any other component typically employed in one or more of the specific applications of system 100 (for example, seat insert 38) as described above. In one example, this coupling can be effectuated with the use of a fastener (for example, the fasteners 22 described above), a lock, such as a bayonet lock, and/or with the use of one or more of a boss 40 and a connector 44. In an exemplary and non-limiting illustrative embodiment, boss 40 can include a screw boss with internal threads for receiving a connector 44, such as a screw, bolt, or the like. In one particular example, boss 40 can be coupled to a portion of the body 16, or formed as part of body 16. Although not so limited, boss 40 can be formed at a location proximate to ports 24.

Further, ports 24 can be further coupled to a conduit 46. Conduit 46 can include can hose, tube (flexible or otherwise), channel, pipe, or the like for permitting the flow of a fluid through it. To facilitate the coupling of conduit 46 to port 24, one or more flanges 26 can be coupled to, or formed as a part of, ports 24. For example, flange 26 can include male bars or bibs (e.g., straight, right-angle, etc.) for assisting the fitting of a conduit around the outer circumference of port 24. Alternatively, flange 26 can disposed within an inner perimeter of port 24 such that flanges 26 couple to the outer perimeter of conduit 46.

For purposes of clarity and understanding, one or more of these components may not be specifically described or shown while, nevertheless, being present in one or more embodiments of the invention, such as in a commercial embodiment, as will be readily understood by one of ordinary skill in the art.

Particular embodiments of the invention may be described below with reference to block diagrams and/or operational illustrations of methods. It will be understood that each block of the block diagrams and/or operational illustrations, and combinations of blocks in the block diagrams and/or operational illustrations, can be implemented by analog and/or digital hardware, and/or computer program instructions. Such computer program instructions may be provided to a processor of a general-purpose computer, special purpose computer, ASIC, and/or other programmable data processing system. The executed instructions may create structures and functions for implementing the actions specified in the block diagrams and/or operational illustrations.

The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions. Discussion of singular elements can include plural elements and vice-versa.

The inventions have been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to fully protect all such modifications and improvements that come within the scope or range or equivalent of the following claims.

What is claimed is:

1. An apparatus for controlling the flow of a fluid, the apparatus comprising:
an upper component comprising a body and a core tube, wherein the upper component is formed as a single manufactured component;
a lower component, comprising a seat insert and a core, wherein the lower component is formed as a single manufactured component; and
a coil adapted to regulate an amount of fluid flowing through the apparatus;
wherein the upper component and the lower component are formed as separate units and adapted to be coupled to one another with a coupler.

2. The apparatus for controlling the flow of a fluid according to claim 1, further comprising a fastener, wherein the fastener is adapted to couple the coil to the upper component.

3. The apparatus for controlling the flow of a fluid according to claim 1, further comprising a disc, wherein the disc is adapted to couple to the core.

4. The apparatus for controlling the flow of a fluid according to claim 3, further comprising a diaphragm, wherein the diaphragm is adapted to isolate the seat insert from the disc.

5. The apparatus for controlling the flow of a fluid according to claim 3, further comprising a diaphragm, wherein the diaphragm is a piloted diaphragm adapted to be disposed between the seat insert and the disc.

6. The apparatus for controlling the flow of a fluid according to claim 1, further comprising first and second ports disposed at a first angle with respect to the apparatus, wherein the first and second ports are inlet and outlet ports, respectively.

7. The apparatus for controlling the flow of a fluid according to claim 6, wherein the first angle is one-hundred and eighty degrees.

8. The apparatus for controlling the flow of a fluid according to claim 6, wherein the first angle is ninety degrees.

9. The apparatus for controlling the flow of a fluid according to claim 6, wherein at least one of the first and second ports further comprises a flange.

10. The apparatus for controlling the flow of a fluid according to claim 1, wherein the coupler is a weld joint, a snap-fit device, or an adhesive.

11. The apparatus for controlling the flow of a fluid according to claim 1, further comprising a seal, wherein the seal is adapted to be disposed between the upper and lower components.

12. A system for controlling the flow of a fluid, the system comprising:
an apparatus comprising:
an upper component comprising a body and a core tube, wherein the upper component is formed as a single manufactured component;
a lower component, comprising a seat insert and a core, wherein the lower component is formed as a single manufactured component; and
a coil adapted to regulate an amount of fluid flowing through the apparatus;
wherein the upper component and the lower component are formed as separate units and adapted to be coupled to one another with a coupler; and
a manifold, wherein the upper component is adapted to be coupled to the manifold.

13. The system for controlling the flow of a fluid according to claim 12 wherein the coupler includes a snap-fit device.

14. The system for controlling the flow of a fluid according to claim 12, wherein the upper component further includes a boss adapted to receive a connector.

15. The system for controlling the flow of a fluid according to claim 14, wherein the connector is a screw.

16. The system for controlling the flow of a fluid according to claim 12, wherein the upper component is formed with molded plastic.

17. The system for controlling the flow of a fluid according to claim 12, wherein the core is a float-style core.

18. The system for controlling the flow of a fluid according to claim 12, wherein the coil is a solenoid, further wherein the flow of the fluid is regulated by the amount of current flowing through the solenoid.

19. The system for controlling the flow of a fluid according to claim 12 further comprising first and second ports, wherein at least one of the first and second ports includes a flange.

20. The system for controlling the flow of a fluid according to claim 19, wherein the first and second ports are adapted to be coupled to a conduit.
